(19) United States
(12) Patent Application Publication
(10) Pub. No.: US 2010/0296797 A1
(43) Pub. Date: Nov. 25, 2010

(54) VIDEO SYSTEM

(75) Inventor: Paulus T.A. Thijssen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/680,591

(22) PCT Filed: Sep. 30, 2008
(86) PCT No.: PCT/IB08/53970

§ 371 Date: Jun. 28, 2010

(30) Foreign Application Priority Data
Oct. 3, 2007 (EP) 07117806.5

(51) Int. Cl. H04N 5/76

(52) U.S. Cl. 386/296; 386/E05.002

(57) ABSTRACT

A video system (100) comprises an input (102) for receiving a plurality of broadcast content channels. A tuner (104) generates a content signal corresponding to at least one of the broadcast content channels. A time shift buffer (106) stores the content signal generated by the tuner to provide a time shift capability. A storage means (108) for stores a profile, the profile comprising one or more preference settings, wherein a preference setting comprises at least one preferred channel and at least one corresponding time criterion, the preference setting indicating that the content signal corresponding to the preferred channel is to be stored in the time shift buffer when the corresponding time criterion is satisfied. Control means (110) cause the tuner to generate the content signal of the preferred channel in agreement with the time criterion.

### FIELD OF THE INVENTION

The invention relates to a video system. The invention also relates to video recording.

### BACKGROUND OF THE INVENTION

Personal video recorders, such as hard-disk recorders, are known to provide a time shift buffer (TSB). The contents of a broadcast channel is recorded in real-time to the TSB, as it is received by the personal video recorder. Simultaneously, the user may watch the broadcast channel via his or her television. Because the content of the broadcast channel is recorded, the user may also pause or rewind the program being watched. Effectively, the user may choose to watch any content that is stored on the TSB. Typically, the content is stored in the TSB only for at most a fixed period of time. For example, only the last 6 hours of received content may be stored. Many personal video recorders delete the content of the TSB when the device is switched off. Timer recordings and manual recordings, on the other hand, are in principle stored permanently, although it is known to automatically delete a timer recording after a certain period of time or after receiving a new episode of a particular series. However, timer recordings and manual recordings are usually stored in a separate file for each recording. Such timer recordings and manual recordings are usually presented to the user as separate entities. For example, a list of available recordings may be presented. On the other hand, the time shift buffer may contain a continuous data stream representing content that was sequentially received while the time shift buffer was switched on. This content comprises the content of a broadcast channel that the video system was tuned into at the moment of recording. Typically the time shift buffer comprises content that was recorded during a continuous time interval. Consequently, due to channel switches, the time shift buffer may comprise content from different channels, the content from different channels being recorded at different times. When content from different channels is recorded, there is usually hardly any gap in time between the end of the recording of the first channel and the start of the recording of the second channel. Typically, the user is enabled to skip to any desired part of the content stored in the time shift buffer by moving a graphical indicator along a time bar using for example a remote control device. The user may play, fast forward, or fast backward the content in the time shift buffer. By doing this, the user may render portions recorded in the time shift buffer during a continuous time interval and from different broadcast content channels. The time shift buffer may be presented in conjunction with a time bar representing the time duration of the recording that is stored in the time shift buffer, through which the user may jump back and forth to view a particular piece of the content stored in the time shift buffer.

### SUMMARY OF THE INVENTION

It would be advantageous to have an improved video system. To better address this concern, in a first aspect of the invention a video system is presented that comprises:

an input for receiving a plurality of broadcast content channels;

a tuner for generating a content signal corresponding to at least one of the broadcast content channels;

a time shift buffer for storing the content signal generated by the tuner to provide a time shift capability;

a storage means for storing a profile, the profile comprising one or more preference settings, wherein a preference setting comprises at least one preferred channel and at least one corresponding time criterion, the preference setting indicating that the content signal corresponding to the preferred channel is to be stored in the time shift buffer when the corresponding time criterion is satisfied;

control means for causing the tuner to generate and the time shift buffer to store the content signal corresponding to the at least one preferred channel at a time in agreement with the corresponding time criterion as indicated by at least one of the preference settings.

The user profile allows the time shift buffer to record content more selectively and more adequately for the user. The user does not have to select the channel to tune to. This is performed automatically by the video system. The user does not have to switch to the appropriate channel, because the video system automatically causes the tuner to generate and the time shift buffer to store the content signal corresponding to at least one preferred channel at the proper time. This is for example useful when being temporarily away from the video system while the video system is turned on and is storing content into the time buffer. In such a case, it is convenient if the stored content signal does not correspond to a (more or less) random channel, but to a channel that has a relatively high probability of broadcasting something that is of interest to the user. Also when using the time-shift viewing feature to view a portion of the content stored somewhat earlier, the user may forget when to switch the channel that is recorded in the time shift buffer in order to view a favorite TV show on another channel. This is handled automatically by the video system at the correct time without requiring user interaction according to the preference settings. The profile and preference settings are used to store information about such preferred channels and the times at which they are preferred. This is because at different times of the day, different channels may be expected to provide interesting broadcast programs.

An embodiment comprises a control input, for example a user interface element, for enabling a user to configure the profile by providing at least one of the preference settings. This allows the user to have a high degree of control of the preference settings.

An embodiment comprises a profiler for generating the profile based on the channels tuned into in the past and times at which those channels were tuned into. This is a very user friendly way of generating the profile, as it does not require the user to provide any detailed explicit information, but his actual usage of the device is used to collect the relevant information.

An embodiment comprises a control input for receiving a command to automatically generate the profile wherein the profiler is arranged for generating the profile in correspondence with the channels and time intervals that are stored in the time buffer at a time of receiving the command. This is very easy to implement, as it does not assume to store any data about channels that are not in the time shift buffer any more.

In an embodiment, the control means is arranged for, upon the video system being switched on, causing the tuner to start generating and the time shift buffer to start storing the content signal corresponding to the at least one preferred channel at a time in agreement with the corresponding time criterion as indicated by at least one of the preference settings. This is particularly user friendly, because the user may just switch on the video system and walk away from it without explicitly selecting a desired channel, and still the desired channel will be stored in the time shift buffer for later viewing.

In an embodiment, the control means is arranged for causing the tuner to start generating and the time shift buffer to start storing the content signal corresponding to a further at least one preferred channel at a further time in agreement with a further corresponding time criterion as indicated by a further at least one of the preference settings. This is particularly helpful in the case where the profile comprises more than one preference setting. It is also helpful in case a time criterion only becomes satisfied some time after the video system has been switched on.

An embodiment comprises timer recording means for recording a predetermined broadcast program and making it available to the user as a separate video track wherein the control means is arranged for causing the tuner to start generating and the time shift buffer to start storing the content signal corresponding to a preferred channel and in agreement with a corresponding time criterion as indicated by at least one of the preference settings, after the timer recording is finished.

During the timer recording, it may not be possible to store any content in the time shift buffer other than the predetermined broadcast program. This embodiment helps to determine which channel to tune into when the timer recording is finished.

An embodiment comprises an output for providing a signal corresponding to content stored in the time shift buffer. This allows to playback the content stored in the time shift buffer.

An embodiment comprises a method of video recording, comprising receiving a plurality of broadcast content channels, generating a content signal corresponding to at least one of the broadcast content channels, storing the content signal generated by the tuner to provide a time shift capability, storing a profile, the profile comprising one or more preference settings, wherein a preference setting comprises at least one preferred channel and at least one corresponding time criterion, the preference setting indicating that the content signal corresponding to the preferred channel is to be stored in the time shift buffer when the corresponding time criterion is satisfied and causing the tuner to generate and the time shift buffer to store the content signal corresponding to the at least one preferred channel at a time in agreement with the corresponding time criterion as indicated by at least one of the preference settings.

An embodiment comprises a computer program product comprising software for performing the method set forth.

### BRIEF DESCRIPTION OF THE DRAWINGS

These and other aspects of the invention will be further elucidated and described with reference to the drawing, in which:

FIG. 1 illustrates diagrammatically an embodiment;

FIG. 2 illustrates a profile;

FIG. 3 illustrates a list of profiles;

FIG. 4 illustrates some examples of what may be recorded in a time shift buffer; and

FIG. 5 illustrates some more examples of what may be recorded in a time shift buffer.

### DETAILED DESCRIPTION OF EMBODIMENTS

Hard-disk recorders may provide a time shift buffer (TSB). The contents of the channel that is tuned to may be recorded in real-time in the TSB. Simultaneously, the user can watch content that has been broadcast earlier as long as it is stored in the TSB. This principle is called time shifting. Some video recorders automatically start recording a channel in the TSB when the video recorder is switched on. Other video recorders may require an explicit user action to start recording to the TSB. In many video recorders, the length of the time shift buffer is limited to N hours (for example, N=6). After N hours, the oldest part of the TSB will be overwritten.

One of the imperfections of the conventional TSB is that it may be tuned to the wrong channel. When switching on the video recorder, it may tune to the channel it was tuned to when switched off. This may not correspond to the channel one wants to watch when switching on the device. Moreover, while watching some content that is stored in the TSB, the TSB keeps recording the content that is broadcast on the channel it is tuned to. However, at some time an interesting program may start on another channel. This interesting program is missed when the TSB keeps recording the same channel.

Another imperfection is that time shifting only works if the user has performed an explicit action to start the recording to the TSB before the start of the program that he wants to watch. For example, he has to switch on the video recorder, tune the video recorder to the desired channel, and, if TSB recording is not automatic, push the TSB record button to start the TSB.

Some of these imperfections may be overcome. For example, the user may be allowed to define a profile. The TSB may be arranged for automatically recording the desired programs or channels as defined in the profile. This way, more appropriate content may be stored in the time shift buffer. For example if the user has certain habits of regularly watching some broadcast channel at a given time, these habits may be modeled by means of the profile and the TSB may be programmed to record the channels according to the habits of the user.

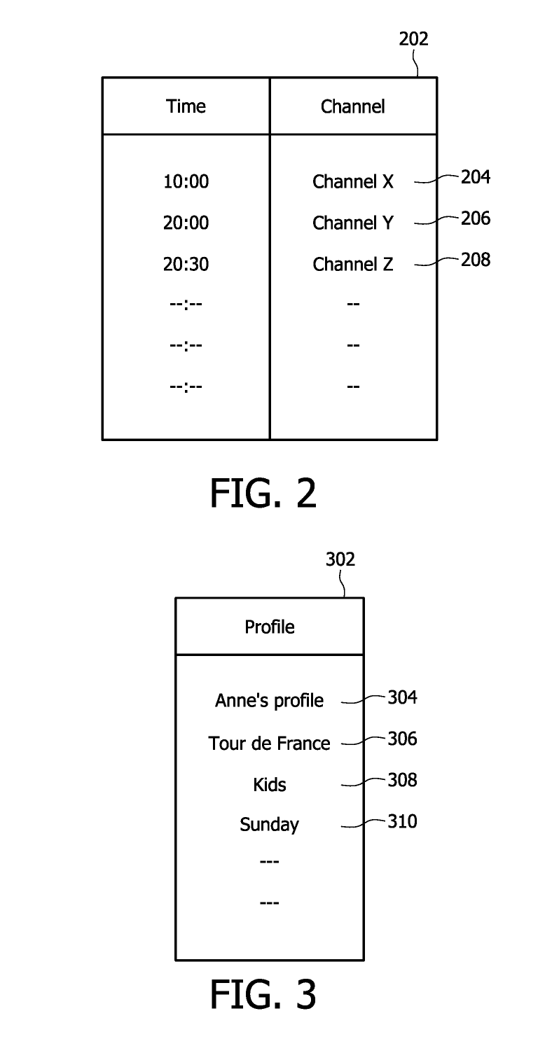

FIG. 2 illustrates schematically an example of a profile 202 that may be shown to a user of the video system.

An example of a profile is the following:

At 10:00, start recording “Channel X” 204;

At 20:00, start recording “Channel Y” 206;

At 20:30, start recording “Channel Z” 208.

Because the time-shift buffer in principle keeps recording as long as the TSB feature or the video recorder is switched on, it may not be necessary to define an end time. The recording of the channel as defined in the profile continues until for example the user switches to another channel, a timer recording starts, or the video recorder or the TSB is switched off Whenever TSB recording is active, it will record a channel, and unless instructed otherwise, the channel as specified in the profile will be tuned into and recorded in the TSB.

Using the profile to record content in the time shift buffer that is relevant to the user, the time shift experience is maintained. This is opposed to explicit recordings such as timer recording. The profile may be used to automate user zapping; i.e., the user does not have to change channels—it is done automatically according to the profile. Often, the profile may not be directed at recording a specific show, but rather may be used to globally indicate which channel has the greatest probability of providing the most interesting content at a given time.

Means may be provided to switch on/off the profile mode. Also, means may be provided to overrule the profile, for example to enable a timer recording or to enable the user to view a specific program he desires to watch. It may be made easy to create or change a profile.

It may also be possible to create a profile that is only valid during a limited period of time. For example, it is possible to create a profile that tunes to a news channel between 20.00 and 20.30, to record the main news program of the day. In this example, if the TSB is switched on before 20.00 or after 20.30, the profile does not specify which channel to tune to. Consequently, the system may tune to the last channel it was tuned to when the system was switched off, or for example it may switch to a predefined default channel, such as channel 1. If the system is switched on between 20.00 and 20.30, it tunes to the news channel, as prescribed by the profile in this example. If the TSB is active and the channel being tuned into is not the news channel, at 20.00 the system automatically tunes to the news channel. At the end of the valid period of the profile, in this example at 20.30, the tuner may tune back to the channel it was tuned to before switching to the channel prescribed by the profile. In an alternative embodiment, it may remain on the news channel until the user switches to another channel.

The profile allows a very simple way to manage tuner behavior whilst keeping the TSB experience.

Multiple profiles may be allowed to be defined. For example, different user profiles may be defined for different users. Also, each day may have a different profile. For example, different profiles may be made for workdays, Saturdays, and Sundays. The video recorder automatically applies the right profile based on the present day. Also, profiles for special events may be created. For example, a different profile may be activated for use during a Soccer World Cup or during, for example, the Tour de France. During such events, the profile may define preference settings corresponding to the channels and times of the day on which these events are broadcast. Alternatively, the system may be programmed by means of titles or keywords that may match titles or keywords of programs in an electronic program guide (EPG). For example, the profile may specify to automatically tune to any live broadcast of a national competition soccer match using the proper title and/or keywords. In case of multiple profiles, it may be made simple to switch between different profiles.

FIG. 3 illustrates a list of profiles 302 presented to a user on a display. The user may be enabled to select one of the profiles from the list to be used. The following profiles are listed: “Anne's profile” 304, “Tour de France” 306, “Kids” 308, and “Sunday” 310. When Anne is watching television, she may activate her profile to obtain programming in the time shift buffer according to her preferences. When the kids are watching television, they may activate their profile. At the beginning of the Tour de France, the “Tour de France” profile 306 may be activated, to allow easy time shifting of Tour de France broadcasts. At the end of the Tour de France, the “Tour de France” profile 306 may be deactivated. On Sundays, the “Sunday” profile 310 may be automatically activated. The user may be enabled to add a new profile, delete an existing profile, rename a profile, view or change the contents of a profile, activate a profile, or deactivate a profile. For example, when Anne's profile 304 is selected for viewing, the profile contents as shown in FIG. 2 may be displayed. The different profiles may have different priorities. This means that, if more than one profile is active and the different active profiles prescribe different channels for tuning to, the channel indicated by the profile that has the highest priority is tuned to. For example, the Tour de France profile 306 may be given priority over the other profiles, because the family may find it important to view as much Tour de France coverage as possible.

To further enhance the video recorder, it may be provided with means to automatically switch on/off at prescribed times and start recording a specified channel. This solves the problem that nothing is available for viewing on the TSB at the time the recorder is switched on. The video recorder may also be provided with means to automatically switch off at a prescribed time or after the device has not received any input command from the user during a predetermined amount of time. This has the advantage that, when the user leaves the unit on because he thinks he may return to view content stored on the TSB, but the user does not have the time to view or forgets about the TSB recording, the recorder is automatically switched off This avoids excessive unnecessary power consumption.

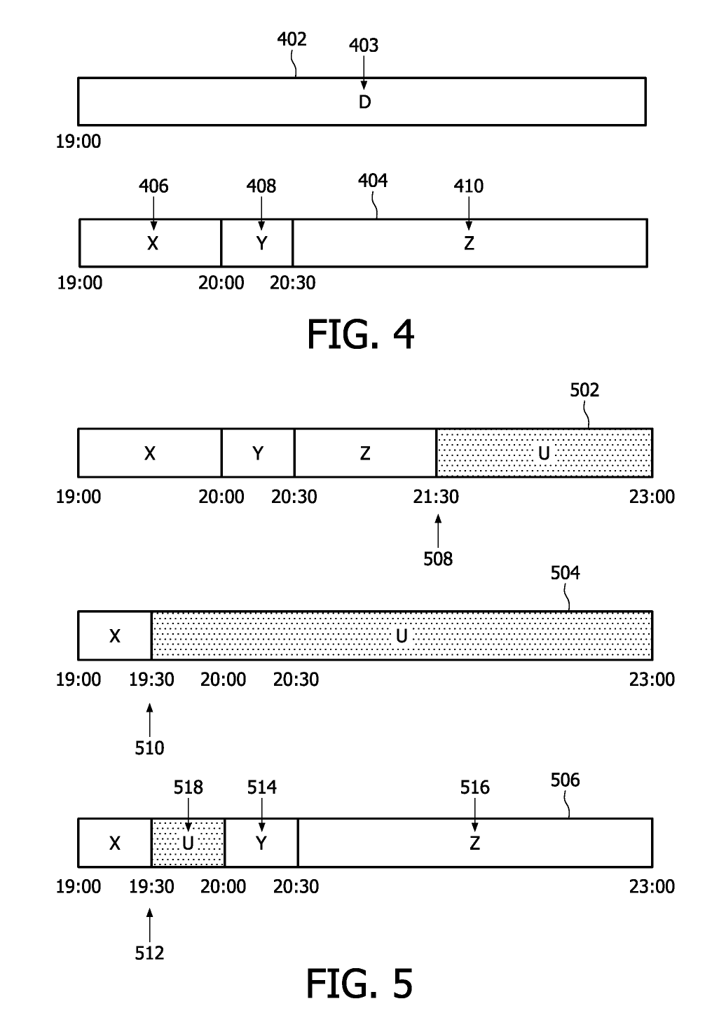

FIG. 4 illustrates examples of the content of a time shift buffer in daily use. Time shift buffer 402 illustrates what happens if the video system is switched on at 19:00, and no profile is available. Time shift buffer 402 corresponds to a prior art time shift buffer. In time shift buffer 402, when the system is switched on at 19:00, the system tunes to the same channel it was tuned to when the system was turned off. The time shift buffer starts recording the content of this channel. This channel is indicated by a D 403 in time shift buffer 402.

Time shift buffer 404 is an illustration of an example of time shift buffer behavior according to an aspect of the invention. Time shift buffer 404 illustrates the use of a time shift buffer in conjunction with the profile 202 shown in FIG. 2. When the system is switched on at 19:00, it determines if there is an active profile. In this example, it determines that the profile 202 shown in FIG. 2 is the only active profile. The system then evaluates the channels and times in the profile. The system thus establishes that after 10:00 and before 20:00, Channel X 204 is the preferred channel. Consequently, the system tunes to Channel X and stores the received content of Channel X 406 in the time shift buffer 404. This is indicated by the letter X in FIG. 4. At 20:00, the system determines from the profile that the preferred channel is Channel Y 208, and hence the system tunes to Channel Y and stores the received content of Channel Y 408 in the time shift buffer 404. This is indicated by the letter Y in FIG. 4. At 20:30, the system determines from the profile that the preferred channel is Channel Z 208, and hence the system tunes to Channel Z and stores the received content of Channel Z 410 in the time shift buffer 404. This is indicated by the letter Z in FIG. 4. The content stored in time shift buffer 404 is available for viewing at any time the user desires to view the content, until the content is erased from the time shift buffer.

FIG. 5 illustrates further examples of time shift buffer behavior according to aspects of the invention. These examples are based on the profile 202 shown in FIG. 2 and used to fill the content of time shift buffer 404, as described above. In time shift buffer 502 it is shown that the user zaps to Channel U at 21:30 508. The fact that the user zaps to another channel (i.e.: selects another channel for viewing) causes the tuner to tune to the selected Channel U, regardless of any profile that may suggest another channel to watch. In this case, the profile indicates Channel Z 208. However, since the user selects Channel U, the system will switch to Channel U and store the content of Channel U 518 in the time shift buffer 502.

In time shift buffer 504 it is illustrated that the user zaps to Channel U at 19:30 510. The user may also provide a command to “ignore the profile”. Alternatively, the system may be arranged for automatically ignoring the profile after a user zap action. Consequently, the profile is ignored for the remainder of the evening and the tuner stays tuned to Channel U.

In time shift buffer 506 it is illustrated that the user zaps to Channel U at 19:30 512. The user may also provide a command to “follow profile induced channel changes”. Alternatively, the system may be arranged for automatically following profile induced channel changes after a user zap action. Consequently, the system follows profile induced channel changes after the user zap action 512. At 20:00, the channel that is the preferred channel according to the user profile 202 of FIG. 2 changes from Channel X 204 to Channel Y 206. Thus, at 20:00, the tuner tunes to Channel Y and starts storing the received content of Channel Y 514 in the time shift buffer 506. At 20:30, the channel that is the preferred channel according to the user profile 202 of FIG. 2 changes from Channel Y 206 to Channel Z 208. Thus, at 20:00, the tuner tunes to Channel Z and starts storing the received content of Channel Z 516 in the time shift buffer 506.

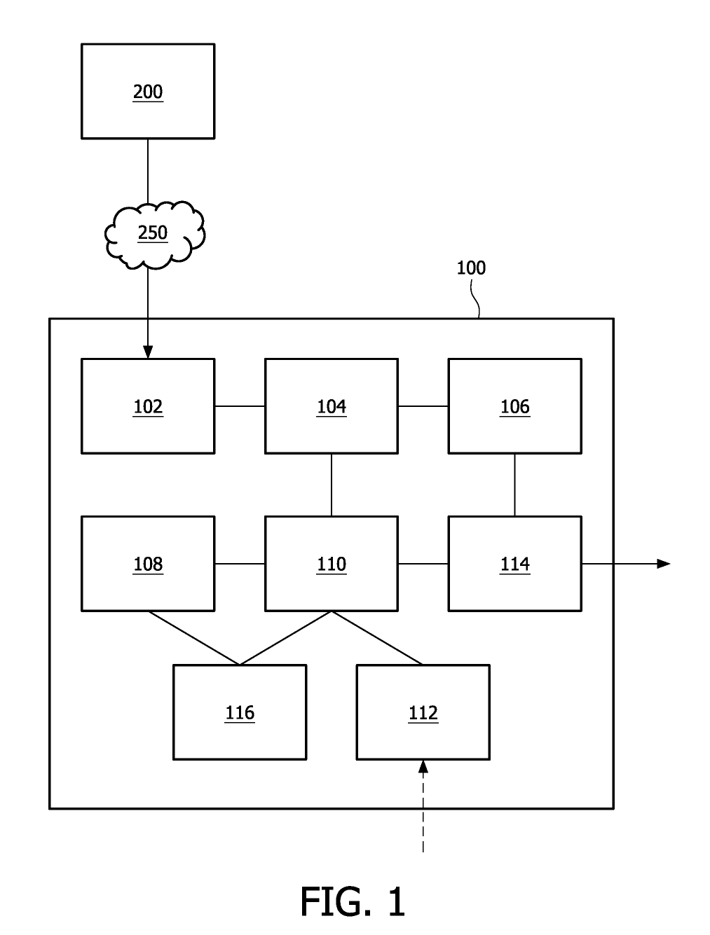

FIG. 1 illustrates an embodiment. It shows a broadcast content provider 200, which provides broadcast content channels via a medium 250 to a video system 100. The medium 250 may be air, cable, or satellite. The content channels may be provided by means of analogue and/or digital signals. Digital signals may be broadcast, for example, in a DVB format such as DVB-S, DVB-T, or DVB-C. Signals may also be broadcast via a digital computer network, such as the Internet (e.g., DVB-IP). The broadcast content provider may be a cable network company, or a broadcast company. The signal comprising a plurality of broadcast content channels is provided at the input 102 of the video system 100. The signal is processed by a tuner 104 to obtain a content signal corresponding to at least one of the broadcast content channels. For example, the tuner 104 demultiplexes an MPEG transport data stream comprising a plurality of content streams. Usually the tuner 104 only extracts one or two channels from the transport data stream. The content signal provided by the tuner 104 is stored in a time shift buffer 106. The content stored in the time shift buffer 106 may be selectively output, for example after conversion into a digital or analogue video signal, by output 114. The output may comprise a SCART or HDMI interface, for example. The output may also comprise an integrated display and/or integrated speakers. Any of the content in the time shift buffer 106 may be shown via the output 114 at any given time, as desired by the user of the system. A control input 112 may be provided to enable the user to input commands to the system, among others to indicate which portion of the stored content should be rendered. Because the content stored in the buffer 106 may be rendered via the output 114 at a desired time after it has been received at the input 102, and while new content is being received via the input 102 and extracted via tuner 104 and stored in the time shift buffer 106, the time shift buffer 106 provides a time shift capability.

The time shift buffer 106 may comprise a file on a hard disk. Alternatively, any other kind of storage medium, for example RAM memory, may be used. The file for example comprises an MPEG video stream. The tuner 104 may deliver a digital signal, which may be stored essentially unmodified in the time shift buffer. The digital signal may also be modified or re-encoded, for example if it is desirable to store the content in a lower quality or if it is desirable to apply digital rights management operations (including e.g. a decryption operation) on the received data before storing it in the time shift buffer. If the tuner 104 provides an analogue signal, the analogue signal is digitized and possibly compressed to obtain a digital content stream suitable for storage in the time shift buffer 106.

The system 100 comprises a storage means 108 for storing a profile. The profile may comprise one or more preference settings, wherein a preference setting comprises at least one preferred channel and at least one corresponding time criterion. The preference setting indicates that the content signal corresponding to the preferred channel is to be stored in the time shift buffer when the corresponding time criterion is satisfied. For example a preference setting may provide an indication to tune to a predetermined preferred channel during a predetermined time interval, or to tune to a predetermined preferred channel while it is showing a predetermined favorite show. The latter example may be realized by using EPG (Electronic Program Guide) functionality or e.g. VPS (Video Programming System) or PDC (Program Delivery Control). The storage means 108 may for example comprise a block of memory of a flash memory or comprise a file on a hard disk.

The system 100 comprises control means 110 for e.g. overall system control. Such control means may comprise for example a processor and processor instructions stored in firmware. The control means 110 may have access to a clock and calendar to provide the actual day and time of day. Such clock and calendar may be maintained internally and/or the information may be received regularly from an external source, e.g. embedded in the signal received at the input 102. The control means 110 may cause the time shift buffer to store the content signal provided by the tuner 104. The control means may also cause the tuner to generate the content signal according to the preference settings in the profile stored in the storage means 108. In effect, the content signal may be stored in the time shift buffer 106 according to the profile. The channel to be recorded in the time shift buffer 106 is determined by control means 110 by comparing the current day and time with the time criterion(s) defined in the profile to establish whether a criterion is satisfied. If so, the preferred channel corresponding to the established criterion is tuned into by the tuner 104 and stored in the time shift buffer 106. The control input also enables the user to override one or more or all of the preference settings, for example by providing a command at the control input 112.

The processor instructions, the profile, and the digital content of the time shift buffer may share the same hardware. For example, a non-volatile copy of these items may be stored on a hard disk. Working copies of these items may be temporarily stored in RAM memory. For example, the profile and the processor instructions may be completely copied into the RAM during start-up when the video system is switched on. Portions of the content may be copied from the hard disk into the RAM just before rendering.

In an embodiment, the control input 112 comprises a user interface element for enabling a user to configure the profile by providing at least one of the preference settings. For example the user may explicitly input a preferred channel and a corresponding time interval. The video system may comprise a menu structure or a graphical interface to allow an easy operation. The user interface may comprise a soft button and/or fields that allow a user to specify the preferred channel(s) and time criterion/criteria.

In an embodiment, the system 100 comprises a profiler 116. This profiler 116 may be used to automatically generate a profile. It does this, for example, by monitoring which channels are being watched during which time interval(s), and by applying intelligent rules and/or statistics. In this way, the profiler 116 may compute the viewing habits of the user. For example it may determine for any given time of day which channel is tuned into most often, and use that channel in the profile for that time of day. The profiler 116 may distinguish between different days of the week, or may distinguish for example between workdays, Saturdays, and Sundays. So different profiles may be generated for different days based on different viewing habits on the different days. This information may be used by the profiler 116 for generating the profile based on the channels tuned into in the past and times at which those channels were tuned into. The profiler 116 may be implemented by means of software processor instructions and/or use the storage media available (RAM, hard disk, etc.) to store the data needed to generate the profile.

In an embodiment, the control input 112 allows reception of a command to automatically generate the profile. In response to such a command, the profiler may generate the profile in correspondence with the channels and time intervals that are stored in the time buffer at that time. This way, only the channel information of recordings currently present in the time shift buffer 106 need to be stored, which reduces complexity of the system.

In an embodiment, the control means 110 uses the profile to determine which channel to tune into when the system 100 is switched on. For example, upon the video system being switched on, the tuner is caused to start generating and the time shift buffer is caused to start storing the content signal corresponding to the at least one preferred channel at a time in agreement with the corresponding time criterion as indicated by at least one of the preference settings.

In an embodiment, the control means 110 keeps track of the time while the system 100 is switched on. If at some time one of the time criteria that was not yet satisfied becomes satisfied, the control means 110 instructs the tuner 104 to tune into the preferred channel corresponding to the newly satisfied time criterion. This causes the preferred channel to be recorded in the time shift buffer 106.

Usually the video system will allow timer recordings. To this end, timer recording means may be provided. The timer recording means may comprise user interface elements for programming one or more timer recordings. These timer recordings usually have priority over the profile. The timer recording means may record a predetermined broadcast program and make it available to the user as a separate video track. After finishing the timer recording, it may not be obvious which channel is the most appropriate to tune into for storing the potentially most interesting content in the time-shift buffer. To this end, the control means may be arranged for causing the tuner to start generating and the time shift buffer to start storing the content signal corresponding to a preferred channel and in agreement with a corresponding time criterion as indicated by at least one of the preference settings, after the timer recording is finished. So, while the timer recordings take priority over the profile, after the timer recording is finished, the time-shift buffer is filled again with content according to the profile.

A method of video recording comprises:

receiving a plurality of broadcast content channels;

generating a content signal corresponding to at least one of the broadcast content channels;

storing the content signal generated by the tuner to provide a time shift capability;

storing a profile, the profile comprising one or more preference settings, wherein a preference setting comprises at least one preferred channel and at least one corresponding time criterion, the preference setting indicating that the content signal corresponding to the preferred channel is to be stored in the time shift buffer when the corresponding time criterion is satisfied; and

causing the tuner to generate and the time shift buffer to store the content signal corresponding to the at least one preferred channel at a time in agreement with the corresponding time criterion as indicated by at least one of the preference settings.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. It will also be appreciated that such a program may have many different architectural designs. For example, a program code implementing the functionality of the method or system according to the invention may be subdivided into one or more subroutines. Many different ways to distribute the functionality among these subroutines will be apparent to the skilled person. The subroutines may be stored together in one executable file to form a self-contained program. Such an executable file may comprise computer executable instructions, for example processor instructions and/or interpreter instructions (e.g. Java interpreter instructions). Alternatively, one or more or all of the subroutines may be stored in at least one external library file and linked with a main program either statically or dynamically, e.g. at run-time. The main program contains at least one call to at least one of the subroutines. Also, the subroutines may comprise function calls to each other. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth. These instructions may be subdivided into subroutines and/or be stored in one or more files that may be linked statically or dynamically.

The carrier of a computer program may be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A video system (100) comprising:
an input (102) for receiving a plurality of broadcast content channels;
a tuner (104) for generating a content signal corresponding to at least one of the broadcast content channels;
a time shift buffer (106) for storing the content signal generated by the tuner to provide a time shift capability;
a storage means (108) for storing a profile, the profile comprising one or more preference settings, wherein a preference setting comprises at least one preferred channel and at least one corresponding time criterion, the preference setting indicating that the content signal corresponding to the preferred channel is to be stored in the time shift buffer when the corresponding time criterion is satisfied;
control means (110) for causing the tuner to generate and the time shift buffer to store the content signal corresponding to the at least one preferred channel at a time in agreement with the corresponding time criterion as indicated by at least one of the preference settings.

2. The video system according to claim 1, further comprising a control input (112) for enabling a user to configure the profile by providing at least one of the preference settings.

3. The video system according to claim 1, further comprising:
a profiler (116) for generating the profile based on the channels tuned into in the past and times at which those channels were tuned into.

4. The video system according to claim 3, further comprising:
a control input (112) for receiving a command to automatically generate the profile;
wherein the profiler is arranged for generating the profile in correspondence with the channels and time intervals that are stored in the time buffer at a time of receiving the command.

5. The video system according to claim 1, wherein the control means is arranged for, upon the video system being switched on, causing the tuner to start generating and the time shift buffer to start storing the content signal corresponding to the at least one preferred channel at a time in agreement with the corresponding time criterion as indicated by at least one of the preference settings.

6. The video system according to claim 1, wherein the control means is arranged for causing the tuner to start generating and the time shift buffer to start storing the content signal corresponding to a further at least one preferred channel at a further time in agreement with a further corresponding time criterion as indicated by a further at least one of the preference settings.

7. The video system according to claim 1, further comprising:
timer recording means for recording a predetermined broadcast program and making it available to the user as a separate video track;
wherein the control means is arranged for causing the tuner to start generating and the time shift buffer to start storing the content signal corresponding to a preferred channel and in agreement with a corresponding time criterion as indicated by at least one of the preference settings, after the timer recording is finished.

8. The video system according to claim 1, wherein the video system further comprises an output (114) for providing a signal corresponding to content stored in the time shift buffer.

9. A method of video recording, comprising:
receiving a plurality of broadcast content channels;
generating a content signal corresponding to at least one of the broadcast content channels;
storing the content signal generated by the tuner to provide a time shift capability;
storing a profile, the profile comprising one or more preference settings, wherein a preference setting comprises at least one preferred channel and at least one corresponding time criterion, the preference setting indicating that the content signal corresponding to the preferred channel is to be stored in the time shift buffer when the corresponding time criterion is satisfied; and
causing the tuner to generate and the time shift buffer to store the content signal corresponding to the at least one preferred channel at a time in agreement with the corresponding time criterion as indicated by at least one of the preference settings.

10. A computer program product comprising software for performing the method according to claim 9.
